(19) United States
(12) Patent Application Publication
(10) Pub. No.: US 2026/0084431 A1
(43) Pub. Date: Mar. 26, 2026

(54) PRINTING FLUID DELIVERY DEVICES

(71) Applicant: HEWLETT-PACKARD DEVELOPMENT COMPANY, L.P., Spring, TX (US)

(72) Inventors: Dorkaitz Alain VAZQUEZ FERNANDEZ, Sant Cugat del Valles (ES); David BUTINYA TEIXIDO, Sant Cugat del Valles (ES); Alvaro DEL BARRIO SANCHEZ, Sant Cugat del Valles (ES); Joan Albert MIRAVET JIMENEZ, Sant Cugat del Valles (ES)

(73) Assignee: HEWLETT-PACKARD DEVELOPMENT COMPANY, L.P., Spring, TX (US)

(21) Appl. No.: 19/118,279

(22) PCT Filed: Oct. 20, 2022
(86) PCT No.: PCT/US2022/078409

§ 371 Date: Apr. 3, 2025

(51) Int. Cl. B41J 2/18; B41J 2/045; B41J 2/175

(52) U.S. Cl. CPC B41J 2/18; B41J 2/0451; B41J 2/17596; B41J 2/04586

(57) ABSTRACT

According to an example, a fluid delivery device comprises a printing fluid pump, a return fluid path including a pressure relief valve to receive printing fluid from an outlet of the pump, and a recirculation valve movable between an open position and a closed position. In the open position of the recirculation valve, a recirculation path from the outlet of the pump towards a supply port connectable to a printing fluid supply is established and, in the closed position, a feeding path from the outlet of the pump towards a printhead port is established. The fluid delivery device comprises a pressure-controlled mode in which the recirculation valve is in the closed position and the pump is to operate at a pressure sufficient to open the pressure relief valve.

### BACKGROUND

Printing fluid delivery devices may be used to move printing fluid along printing fluid paths. In some examples, fluid delivery devices may move printing fluid towards a printhead port. In other examples, a fluid delivery device may move printing fluid towards a supply port. In some examples, a printing system may include a fluid delivery device in fluidic communication with a printing fluid supply and a printhead.

### BRIEF DESCRIPTION OF DRAWINGS

Features of the present disclosure are illustrated by way of example and are not limited in the following figure(s), in which like numerals indicate like elements, in which:

FIG. 1 shows a fluid delivery device to be connected to a printhead and a printing fluid supply, according to an example of the present disclosure;

FIG. 2A shows a fluid delivery device comprising a valve assembly upstream of a pump, according to an example of the present disclosure;

FIG. 2B shows a fluid delivery device comprising a printhead port and an auxiliary printhead port, according to an example of the present disclosure;

FIG. 3A shows a fluid delivery device comprising a sensor to measure a pressure value downstream the pump, according to an example of the present disclosure;

FIG. 3B shows a fluid delivery device comprising a sensor to measure a first pressure value downstream a pump and an auxiliary sensor to measure a second pressure value upstream an auxiliary pump, according to an example of the present disclosure;

FIG. 4 shows a printing system including a fluid delivery device, according to an example of the present disclosure;

FIG. 5 shows a line chart representing a pressure profile downstream a pump of a fluid delivery device, according to an example of the present disclosure;

FIG. 6 shows a second line chart representing a pressure profile downstream a pump of a fluid delivery device over a period of time, according to an example of the present disclosure;

FIG. 7 shows a line chart in which a pressure profile and a second pressure profile, according to an example of the present disclosure.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent, however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Printing systems dispense printing fluid on printing substrates via printheads. These printheads may be part of the printing system or may be removably connected to the printing system via printhead ports. To supply the printheads with printing fluid, printing fluid supplies may be connected to the printing systems via supply ports.

Printing systems may move printing fluid towards a desired location of the printing system along a fluid path. In some examples, to move the printing fluid, the printing system may pressurize regions of the printing system. In an example, a printing system may pressurize a fluid path that fluidly connects a printing fluid supply to a printhead. In some other examples, a printing system may pressurize a fluid path that fluidly connects the printing fluid supply to an auxiliary printing fluid supply.

To perform operations involving printing fluid (e.g., printhead feeding operations, recirculation operations, or recirculation-through-printhead operations), printing systems may use fluid delivery devices fluidly connected to at least one printing fluid supply and at least one printhead. In some examples, in a printhead feeding operation, a fluid delivery device of a printing system may route the printing fluid received from the printing fluid supply towards a printhead connected to a printhead port of the printing system. In other examples, in a recirculation operation, the fluid delivery device of the printing system may move the printing fluid within the printing system (e.g., for instance from a first supply port to a second supply port). In some examples, each of the operations conducted by a printing system may be associated with at least one of a different fluid path and a different set of characteristics of the printing fluid. Examples of printing fluid characteristics include a printing fluid pressure and a printing fluid flow rate. In some examples, the set of characteristics may be controlled using components of the fluid delivery device. Accordingly, the fluid delivery device of a printing system may adjust at least one printing fluid characteristic based on a type of printing operation to be carried out by the printing system.

When performing printing operations under non-nominal conditions (for instance, excessive or deficient pressure levels), printing systems may experience mechanical flaws and/or image quality defects. Examples of issues experienced when operating under non-nominal conditions comprise printhead drooling, air ingestion through the nozzles of the printhead, printing fluid leakage, printhead blockage, partial (or full) blockage of the fluid line, changes in the viscosity of the printing fluid, out-of-ink events, or pigment settling.

Throughout the description, the term “nominal conditions” will be used to refer to a plurality of characteristics that define an effective printing operation involving a movement of printing fluid along a fluid path of a printing system. Examples of characteristics comprise printing fluid flowrate, printing fluid pressure, printing fluid viscosity, and combinations thereof. In some examples, the nominal conditions in a printing operation may be defined as ranges of admissible values. In other examples, the nominal conditions may be related to a pressure value variation over a period of time. In some other examples, the nominal conditions may be defined as a uniform pressure value having a variability within a range of admissible values.

Disclosed herein are fluid delivery devices, printing systems, and methods to reduce the mechanical flaws and image quality defects resulting from the performance of printing operations under non-nominal conditions.

Among others, one of the factors which may influence in the operations conducted by a printing system is the printing fluid pressure. In particular, the pressure values and the variability of these pressure values may create undesired effects while performing printing operations. In an example, when providing a printhead with printing fluid, feeding the printhead with a variable pressure over time may result in a non-uniform ejection of printing fluid on the printing medium. In other examples, when recirculating printing fluid within the printing system, having undesirably low or high pressure levels may cause the printing fluid to move along a portion of the desired fluid path instead of the full fluid path or may result in printhead drooling, printhead leakage or even causing physical damage to some of the components of the printing system.

To adjust the set of characteristics of the printing fluid, fluid delivery devices include a pump (or pumps). In an example, at least one pump parameter may be modified to adjust the set of characteristics of the printing fluid. Examples of pump parameters comprise the flow rate and the power.

However, over the lifespan of the fluid delivery device, the same pump parameters may not effectively adjust the set of characteristics of the printing fluid, thereby leading to non-uniform printing operations. In other words, a set of pump parameters may not lead to a set of printing fluid characteristics over the lifespan of a fluid delivery device.

To effectively conduct operations involving printing fluid in the printing system, a fluid delivery device may comprise a pressure-controlled mode. Under the pressure-controlled mode, the fluid delivery device is to move printing fluid at a pressure value associated with nominal conditions. As a result, image quality defects and mechanical flaws resulting from non-nominal pressures are prevented.

In some examples, in a printhead feeding operation, a printhead in fluidic communication with a fluid delivery device may have to receive printing fluid at a uniform pressure value to prevent image quality defects. Accordingly, the printhead feeding operation may be conducted under the pressure-controlled mode of the fluid delivery device to prevent adverse effects associated with non-uniform pressure values. In some other examples, in a recirculation operation, a fluid delivery device may be configured to move printing fluid towards a supply port at a uniform pressure value to prevent mechanical flaws. Accordingly, the recirculation operation may be performed under the pressure-controlled mode of the fluid delivery device.

According to an example, a fluid delivery device may comprise a printing fluid pump, a return fluid path to receive printing fluid from an outlet of the pump, and a recirculation valve movable between an open position and a closed position. To perform printing operations under nominal conditions, the fluid delivery device may include a pressure relief valve in the return fluid path. In some examples, a set pressure of the pressure relief valve may be set based on a pressure value of the printing fluid in the pressure-controlled mode of the fluid delivery device. As a result, the pressure levels provided by the fluid delivery device when performing printing fluid operations under the pressure-controlled mode will be within admissible values associated with the nominal conditions.

As used herein, the term “pressure relief valve” will be used to refer to valves designed or set to open upon a pressure difference between an inlet and an outlet of the valve is greater than a set pressure. When the set pressure is exceeded, the relief valve is forced open and a portion of the fluid is diverted through the pressure relief valve. In a fluid delivery device, as the printing fluid is diverted via the pressure relief valve, the pressure of a fluid path downstream the return fluid path will stop rising, thereby leading to a uniform printing fluid pressure. In some examples, a set pressure for a pressure relief valve used in a fluid delivery device may be set within a range within a range from 8 psi (55 kPa) to 14 psi (96 kPa), such as a pressure within a range from 10 psi (68 kPa) to 12 psi (82 kPa). In an example, a pressure relief valve may have a set pressure within a pressure range from 9.4 psi (65 kPa) to 12.3 psi (85 kPa).

According to some examples, a fluid delivery device comprises a pressure-controlled mode in which the printing fluid is moved at a pressure value associated with nominal conditions of printing operations. In the pressure-controlled mode of a fluid delivery device, the pump of the fluid delivery device is to move printing fluid towards the printhead at a pressure greater than the set pressure of the pressure relief valve. As a result, the printing fluid moves towards the printhead at a uniform pressure influenced by the pressure relief valve. In some other examples, the fluid delivery device may further comprise a non-controlled pressure mode in which the pump is to operate at a pressure insufficient to open the pressure relief valve. Accordingly, in the non-controlled pressure mode, the fluid delivery device may provide printing fluid at a non-uniform pressure due to the pressure relief valve does not detour printing fluid from the outlet of the pump via the return fluid path. In some examples, the non-controlled pressure mode may be used during recirculation operations. The non-controlled pressure mode may be alternatively referred to as recirculation mode.

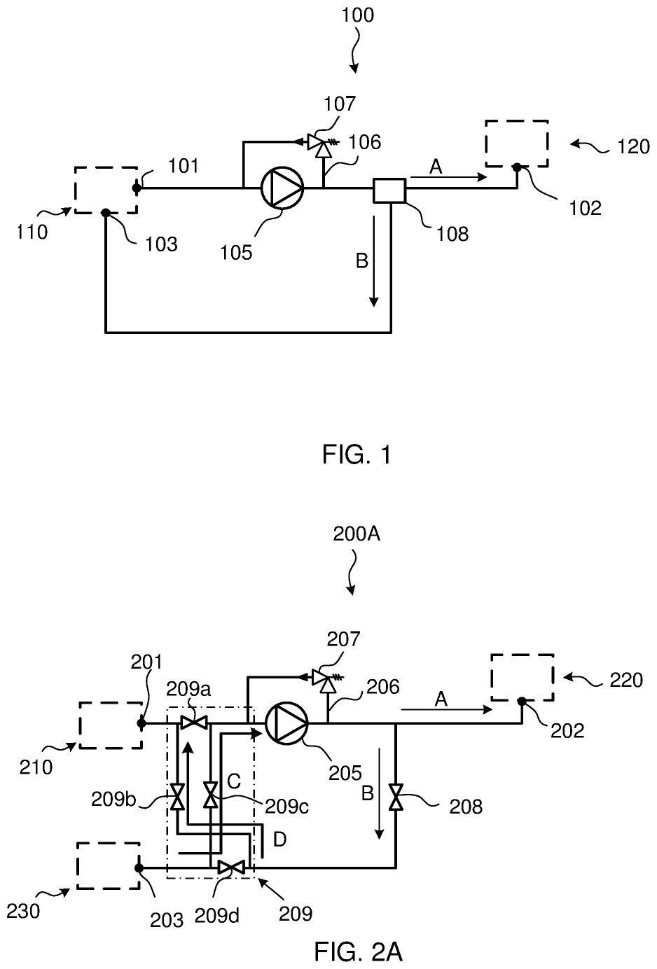

Referring now to FIG. 1, a fluid delivery device 100 is shown. The fluid delivery device 100 may be used to perform printing operations. The fluid delivery device 100 comprises a printing fluid pump 105 to receive printing fluid from a first supply port 101 and a return fluid path 106 to receive printing fluid from an outlet of the pump 105. The return fluid path 106 includes a pressure relief valve 107.

In the fluid delivery device 100, the printing fluid pump 105 is to receive printing fluid from a printing fluid supply 110 fluidly connected via a first supply port 101. On the other hand, the outlet of the pump 105 is fluidly connected to a printhead 120 via a printhead port 102. In addition, the fluid delivery device 100 further comprises a second supply port 103 connectable to the printing fluid supply 110. As previously explained, each of the printing fluid supply 110 and the printhead 120 may be part of the fluid delivery device or may be removably connected to the respective ports of the fluid delivery device 100.

The fluid delivery device 100 further comprises a recirculation valve 108 movable between an open position and a closed position. In the open position of the recirculation valve 108, a recirculation path from the outlet of the pump 105 towards the second supply port 103 is established. In the closed position of the recirculation valve 108, a feeding path from the outlet of the pump 105 towards the printhead port 102 is established. In FIG. 1, the feeding path is represented by arrow A and the recirculation path is represented by arrow B.

As previously explained, the use of a pressure relief valve in a fluid delivery device enables to obtain a pressure-controlled mode. In FIG. 1, the fluid delivery device 100 comprises a pressure-controlled mode in which the recirculation valve 108 is in the closed position and the pump 105 is to operate at a pressure sufficient to open the pressure relief valve 107. In the pressure-controlled mode, the printing operations conducted by the fluid delivery device 100 are performed under nominal conditions.

In some other examples, the fluid delivery device 100 may further comprise a recirculation mode in which the recirculation valve 108 is in the open position and the pump 105 is to operate at a pressure insufficient to open the pressure relief valve 107. Accordingly, in the recirculation mode, the printing operations may be performed in nominal or non-nominal conditions based on the performance of each of the components of the fluid delivery device 100. In some examples, the recirculation mode of the fluid delivery device 100 may be used to perform operations in which printing fluid is not dispensed on printing media, such as recirculation operations. However, as explained above, in some examples a set of pump parameters may not result in the same printing fluid characteristics over the lifespan of the fluid delivery device 100.

Although in the fluid delivery device 100 the first supply port 101 and the second supply port 103 are connectable to the same printing fluid supply (i.e., printing fluid supply 110), in other examples, the second supply port is connectable to a second, different, printing fluid supply.

Throughout the description, the expression “a pump to operate at a pressure sufficient to open a pressure relief valve” will be used to refer to a pump controlled or operated to provide a pressure differential between its inlet and its outlet that results in a pressure differential between an inlet and an outlet of the pressure relief valve greater than the set pressure of the pressure relief valve. Similarly, the expression “a pump to operate at a pressure insufficient to open a pressure relief valve” will be used to refer to a pump controlled or operated to provide a pressure differential between its inlet and its outlet that results in a pressure differential between an inlet and an outlet of the pressure relief valve lower than the set pressure of the pressure relief valve.

According to some examples, a fluid delivery device may include a pump having an inlet in fluidic communication with one of a first printing fluid supply port to be connected to a first printing fluid supply and a second printing fluid supply port to be connected to a second printing fluid supply. In the open position of the recirculation valve of the fluid delivery device, the recirculation path may be established from the outlet of the pump to one of the first supply port and the second supply port (i.e., the recirculation path is established from the outlet of the pump towards a supply port connectable to a printing fluid supply).

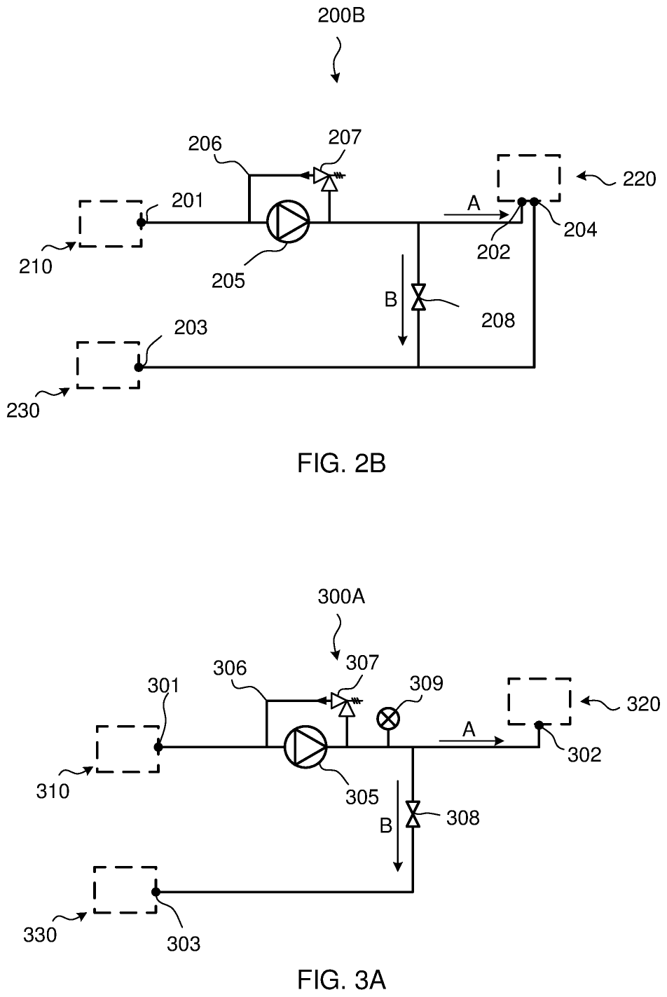

Referring now to FIG. 2A, a fluid delivery device 200A comprising a valve assembly 209 upstream of a printing fluid pump 205 is shown. The fluid delivery device 200A comprises a first supply port 201 connectable to a first printing fluid supply 210, a second supply port 205 connectable to a second printing fluid supply 230, and a first printhead port 202 connectable to a printhead 220. In other examples, the first supply port 201 and the second supply port 205 may be connected to the same printing fluid supply, as previously explained in the fluid delivery device 100 of FIG. 1. The fluid delivery device 200A further comprises a return fluid path 206 that fluidly connects an outlet of the pump 205 to an inlet of the pump 205 and a recirculation valve 208 movable between an open position and a closed position. In the fluid delivery device 200, the return fluid path 206 includes a pressure relief valve 207 having a set pressure.

As explained above, in the open position of the recirculation valve 208, a recirculation path from the outlet of the pump 205 towards a supply port (i.e., first supply port 201 or second supply port 203) is established. On the other hand, in the closed position of the recirculation valve 208, a feeding path from the outlet of the pump 205 towards the printhead port 202 is established.

In FIG. 2A, the valve assembly 209 routes printing fluid within the fluid delivery device 200. In particular, the valve assembly 209 may be used for defining the recirculation path through which the printing fluid is to move in the open position of the recirculation valve 208. The valve assembly 209 of the fluid delivery device 200 is switchable between a forward state and a reverse state. In the forward state, the inlet of the pump 205 is fluidly connected to the first supply port 201 and a recirculation path is established from the outlet of the pump 205 towards the second supply port 203. In the reverse state of the valve assembly 209, the inlet of the pump 205 is fluidly connected to the second supply port 203 and the recirculation path is defined from the outlet of the pump 205 towards the first supply port 201.

To define the states, the valve assembly 209 may include valves 209a, 209b, 209c, and 209d for routing printing fluid towards the first printing fluid supply 210 via the first supply port 201 or the second printing fluid supply 230 via the second supply port 203. Likewise, the valve assembly 209 is used for feeding the pump 205 with printing fluid from the first printing fluid supply 210 or the second printing fluid supply 230. Valves 209a and 209d may be normally open to fluid flow and valves 209b and 209c may be normally closed to fluid flow. In some examples, in the forward state of the valve assembly 209, valves 209a and 209d are open and valves 209b and 209c are closed and, in the reverse state of the valve assembly 209, valves 209a and 209d are closed and valves 209b and 209c are open.

In FIG. 2A, the valve assembly 209 is in the reverse state. Accordingly, valves 209a and 209d are closed and valves 209b and 209c are open. As a result, the pump 205 is to receive printing fluid from the second printing fluid supply 230 along the fluid path represented by arrow C. When the recirculation valve 208 is in the open position, printing fluid will be moved along a recirculation path represented by arrow B and D.

Referring now to FIG. 2B, a fluid delivery device 200B including an auxiliary printhead port 204 is shown. Elements of the fluid delivery device 200B previously explained in reference to the fluid delivery device 200A of FIG. 2A have been referenced using the same reference numerals. The fluid delivery device 200B comprises a printing fluid pump 205, a return fluid path 206, a pressure relief valve 207 in the return fluid path 206, and a recirculation valve 208 movable between an open position and a closed position. The printing fluid pump 205 is to receive printing fluid from a first supply port 201 and the return fluid path 206 fluidly connects an outlet of the pump 205 with an inlet of the printing fluid pump 205. The first supply port 201 is connectable to a first printing fluid supply 210 represented in dashed line.

The recirculation valve 208 of the fluid delivery device 200B is in a recirculation line that fluidly connects the outlet of the pump 205 to a second supply port 203. In FIG. 2B, the second supply port 203 is connectable to a second printing fluid supply 230. In some other examples, the second supply port 203 may be connectable to the first printing fluid supply 210. The fluid delivery device 200B further comprises a printhead port 202 and the auxiliary printhead port 204. The auxiliary printhead port 204 is fluidly connected to a portion of the recirculation line downstream the recirculation valve 208. The printhead port 202 and the auxiliary printhead port 204 are connectable to a printhead 220.

In some examples, the printhead 220 to be connected to the printhead port 202 and the auxiliary printhead port 204 may be a dummy printhead. As used herein, the term “dummy printhead” is used to refer to a printhead which does not include nozzles for drop ejection and that is used for routing printing fluid from first port to a second port. In the context of FIG. 2B, the first port may correspond to the printhead port 202 and the second port may correspond to the auxiliary printhead port 204. When connecting a dummy printhead to the printhead port 202 and the auxiliary printhead port 204, a recirculation path from the outlet of the pump 205 towards the second supply port 203 may include a fluid path along the dummy printhead. Upon a dummy printhead is connected to the printhead port 202 and the auxiliary printhead port 204, the fluid delivery device 200B further comprises a through-dummy recirculation mode in which the recirculation valve 208 is in the closed position, the pump 205 is to operate at a pressure insufficient to open the pressure relief valve 207, and the recirculation path includes a fluid path along the dummy printhead towards the second supply port 203.

In some other examples, a recirculation-through printhead may be performed along a printhead including nozzles for dispensing printing fluid. To perform the recirculation through the printhead, a back pressure may have to be generated via the auxiliary printhead port 204. In an example, to generate the back pressure, the recirculation line of the fluid delivery device 200B may further comprise an auxiliary pump having an outlet in fluidic communication with the second supply port 203 and the auxiliary printhead port 204 may be fluidly connected to an inlet of the auxiliary pump. Then, upon the printhead 220 is connected to the printhead port 202 and the auxiliary printhead port 204, the fluid delivery device 200B further comprises a through-printhead recirculation mode in which the recirculation valve 208 is in the closed position, the pump 205 is to operate at a pressure sufficient to open the pressure relief valve 207, and the auxiliary pump is to operate at a threshold back pressure. In some examples, the threshold back pressure may be a pressure offset with respect to the set pressure of the pressure relief valve.

According to some examples, fluid delivery devices may comprise pressure sensors to measure a pressure of the printing fluid. Based on the measurements of the pressure sensor and an operating operation mode of the fluid delivery device, a controller operatively connected to the pressure sensors may perform a diagnostic of the fluid delivery device. In this way, when performing an operation with the fluid delivery device, the operation conducted by the fluid delivery device will be monitored, thereby avoiding causing damage to the printing medium and/or components of the fluid delivery device. In an example, the pressure measurements during the operation of the fluid delivery device may be compared to a threshold value (or a plurality of threshold values) associated with malfunction events in the fluid delivery device. Examples of malfunction events that may be identified using a pressure sensor comprise depletion events (e.g., an out of ink event of the first printing fluid supply or the second fluid supply), leakage events (e.g., printhead leakage), and blockage events (e.g., the printhead and/or a fluid line).

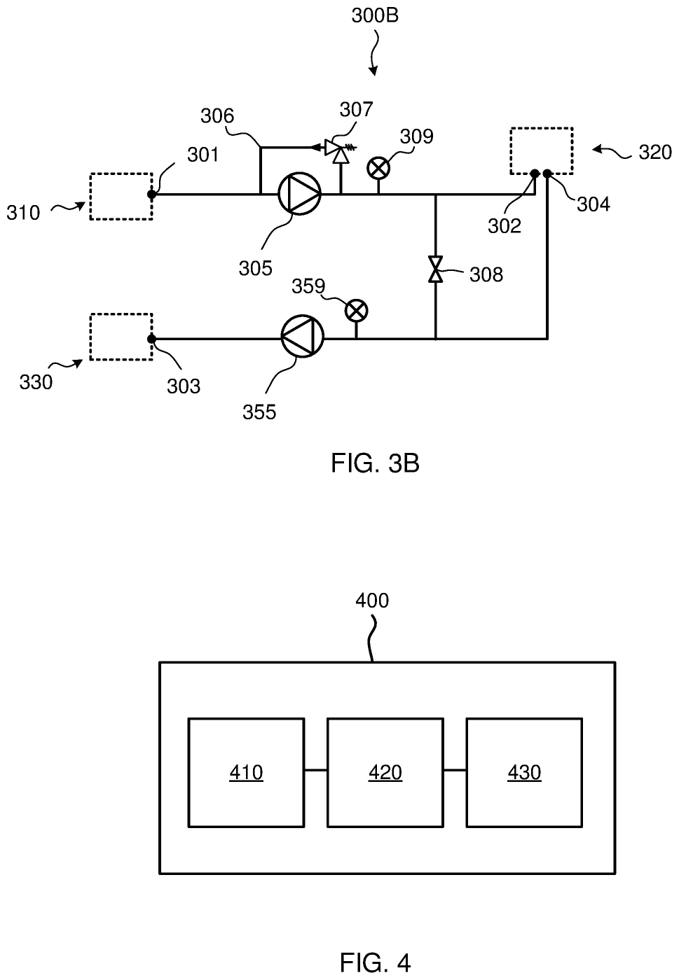

Referring now to FIG. 3A, a fluid delivery device 300A comprising a pressure sensor 309 to measure a pressure in a fluid path defined downstream a return fluid path 306 is shown. The return fluid path 306 includes a pressure relief valve 307. The fluid delivery device 300A further comprises a printing fluid pump 305, a recirculation valve 308, a first supply port 301 connectable to a first printing fluid supply 310, a second supply port 303 connectable to a second printing fluid supply port 330, and a printhead port 302 connectable to a printhead 320.

In the fluid delivery device 300A, the recirculation valve 308 is part of a recirculation line that fluidly connects an outlet of the pump 305 with the second supply port 303, and the pressure sensor 309 is to measure a pressure in a fluid path defined downstream the return fluid path 306 and upstream the recirculation line. In some examples, the pressure sensor 309 may be operatively connected to a controller of a printing system, the controller to determine a malfunction event in the fluid delivery device 300A based on the measure pressure and an operating mode of the fluid delivery device 300A. Examples of operating modes under which the fluid delivery device 300A can conduct printing operations are a pressure-controlled mode and a recirculation mode. As previously explained, under the pressure-controlled mode, the recirculation valve 308 is in the closed position and the pump is to operate at a pressure sufficient to open the pressure relief valve 307.

In some examples, a malfunction event in the fluid delivery device 300A may be determined upon a pressure measured by the pressure sensor 309 is greater than a first threshold value or lower than a second threshold value. Accordingly, in an example, a controller operatively connected to the pressure sensor 309 may determine a printhead blockage event upon the measured pressure is greater than a blockage pressure value and a depletion event upon the measured pressure is lower than a depletion threshold value. In some examples, the blockage pressure value associated with the printhead blockage event may be different based on the operating mode of the fluid delivery device.

Referring now to FIG. 3B, a fluid delivery device 300B comprising a pressure sensor 309 downstream a pump 305 and an auxiliary sensor 359 upstream an auxiliary pump 355 is shown. Each of the pressure sensor 309 and the auxiliary sensor 359 may be operatively connected to a controller of a printing system including the fluid delivery device 300B. As explained above in reference to FIG. 3A, the pressure sensors 309 and 359 may be used for determining a malfunction event in the fluid delivery device 300B. However, due to the fluid delivery device 300B comprises an auxiliary printhead port 304, a malfunction event may also be determined during a recirculation-through-printhead mode. The fluid delivery device 300B comprises a recirculation line including a recirculation valve 308 movable between an open position and a closed position and the auxiliary pump 355. The auxiliary pump 355 has its outlet fluidly connected to a second supply port 303 connectable to a second printing fluid supply 330 and its inlet fluidly connected to an auxiliary printhead port 304.

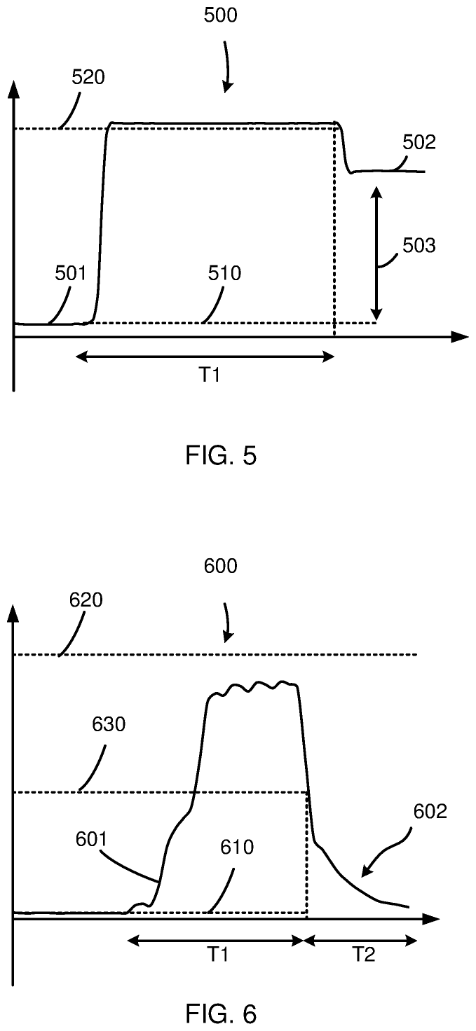

In the fluid delivery device 300B, the pressure sensor 309 is to measure a first pressure downstream return fluid path 306 and the auxiliary sensor 359 is to measure a second pressure upstream the inlet of the auxiliary pump 355. In an example, the controller operatively connected to the pressure sensors 309 and 359 is to determine a malfunction event in the fluid delivery device based on the measured pressures and an operating mode of the fluid delivery device 300B. Examples of malfunction events determined based on the pressure measurements include a printhead blockage event, and a depletion event such as a leakage event or an out-of-ink event. Additional explanation about the determination of malfunction events will be provided in reference to FIGS. 5 to 7.

Referring now to FIG. 4, a printing system 400 including a fluid delivery device 420 is shown. The printing system 400 further comprises a printing fluid supply 410 and a controller 430. The printing system 400 may operate in a pressure-controlled mode, thereby reducing the negative effects resulting from non-nominal pressure conditions during printing operations. In particular, as previously explained, the fluid delivery device 420 comprises the pressure-controlled mode in which a pump in fluidic communication with the printing fluid supply 410 is to operate at a pressure sufficient to open a pressure relief valve in fluidic communication an outlet of the pump. The fluid delivery device 420 further comprises a recirculation valve (e.g., recirculation valves 108, 208 and 308) movable between an open position in which a recirculation path from the outlet of the pump towards a supply port (e.g., first supply port 101, 201, 301 or second supply port 103, 203, 303) is established and a closed position in which a feeding path from the outlet of the pump to a printhead port is established. In the pressure-controlled mode, the recirculation valve is in the closed position such that the printing fluid is moved by the pump towards the printhead port connectable to a printhead. The controller 430 is to operate the recirculation valve of the fluid delivery device 420 based on the operating mode in which the printing system is to conduct a printing operation. Accordingly, to set the fluid delivery device in the pressure-controlled mode, the controller 430 is to operate the recirculation valve to be in the closed position. In an example, the controller 430 is operatively connected to the recirculation valve such that the controller can remotely control a position of the recirculation valve.

In some examples, the fluid delivery device 420 may correspond to any of the fluid delivery device previously explained in reference to FIGS. 1 to 3B. In some examples, the fluid device 420 may include a pressure sensor (e.g., pressure sensor 309) to measure a pressure, and based on the measured pressure, the controller 430 may determine a malfunction event in the fluid delivery device 420. In some other examples, the fluid delivery device 420 may include a pressure sensor (e.g., pressure sensor 309) and an auxiliary pressure sensor (e.g., auxiliary pressure sensor 359), and based on the measured pressures, the controller 430 may determine a malfunction event in the fluid delivery device 420.

In other examples, the fluid delivery device 420 may further comprise an auxiliary pump to create a back pressure to a printhead fluidly connected to an auxiliary printhead port of the fluid delivery device, as previously explained in reference to the fluid delivery device 200B in FIG. 2B.

Referring now to FIG. 5, a line chart 500 representing a pressure profile 501 measured downstream a return fluid path (e.g., return fluid path 106, 206, and 306) and upstream a printhead port (e.g., printhead port 102, 202, and 302) and a recirculation valve (e.g., recirculation valves 108, 208, and 308) is shown. In an example, the pressure profile 501 corresponds to a plurality of pressure values measured using a pressure sensor (e.g., pressure sensor 309 in FIGS. 3A and 3B). The Y-axis of chart 500 represents pressure values and the X-axis represents time. Over the time T1, a pump (e.g., printing fluid pump 105, 205, and 305) of the fluid delivery device is turned on thereby creating a pressure differential between its inlet and outlet.

Line chart 500 comprises two horizontal reference lines 510 and 520. The first reference line 510 represents a pressure value when the pump of the fluid delivery device is turned off. On the other hand, the second reference line 520 represents a sensor saturation value. If the pressure measurement by the pressure sensor is equal to or greater than the sensor saturation value, the pressure sensor saturates. Hence, the pressure sensor may not accurately measure pressure values above the sensor saturation value. In an example, a printhead blockage may be associated with the pressure profile 501 being equal or greater than the sensor saturation value over a period of time T1. In some examples, the period of time T1 may be set as a maximum admissible time over which the pressure sensor can be in a saturated state. To determine a malfunction event in the fluid delivery device, once the pressure profile 510 is equal or greater than the sensor saturation value over the period of time T1, the pump is turned off. Once turned off, in chart 500, the pressure profile 501 decreases to a steady pressure value 502, thereby resulting in a pressure difference 503 with respect to the first reference line 510 (i.e., pressure before turning on the pump). Hence, due to the pressure does not return to the pressure values represented by the first reference line 510, the pressure difference 503 indicates a malfunction event in which an element is blocking a fluid path along the printhead. Accordingly, a controller operatively connected to the pressure sensor may determine a blockage event.

In some examples, the pressure sensor used to measure the pressure profile 501 may not saturate during operation of the fluid delivery device. In other words, instead of associating a printhead blockage with a saturation of the sensor over the period of time T1, the printhead blockage may be associated with a pressure exceeding a threshold pressure value.

Referring now to FIG. 6, a line chart 600 representing a pressure profile 601 is shown. As previously explained in FIG. 5, the pressure profile may be obtained using a pressure sensor such as the pressure sensor 309 in FIGS. 3A and 3B. In some examples, the pressure profile 601 may be measured via a pressure sensor located downstream a return fluid path (e.g., return fluid path 106, 206, and 306) and upstream a printhead port (e.g., printhead port 102, 202, and 302) and a recirculation valve (e.g., recirculation valves 108, 208, and 308). In this way, the measurements by the pressure sensor may be used to determine malfunction events along multiple fluid paths.

In chart 600, three horizontal reference lines are represented in dashed line. The first reference line 610 represents a pressure value before turning on the pump of the fluid delivery device, the second reference line 620 represents an upper threshold pressure value associated with a printhead blockage event, and the third reference line 630 in between the first reference line 610 and the second reference line 620 represents a threshold pressure value associated with a depletion event. In some examples, the threshold pressure value associated with the printhead blockage event (i.e., the second reference line 620) may be alternatively referred to as a blockage pressure value and the threshold pressure value associated with the depletion event (i.e., the third reference line 630) may alternatively referred to as a depletion pressure value. As previously described, a depletion event may correspond to an out-of-ink event or a printhead leakage event. Hence, if the pressure profile 601 decreases below the bottom pressure value represented by the third reference line 630, the depletion event may correspond to a printhead leakage or an out-of-ink event.

In FIG. 6, the pump of the fluid delivery device is turned on over a period of time T1. As a result, the pressure profile 601 is within a range of pressures defined between the lower pressure value and the upper pressure value. However, after T1, the pressure profile 601 decreases below the third reference line 630, thereby indicating that the fluid delivery device is experiencing a malfunction event in the form of a depletion event. To determine the type of depletion event being experienced by the fluid delivery device, the pump of the fluid delivery device is turned off over a period T2. Over the period T2, the pump does not create any pressure differential, but the pressure profile 601 has a negative slope 602. This behavior indicates that the printhead of the fluid delivery device is experiencing a printhead leakage. In some other examples, the pressure profile 601 may have a steady pressure value over the period T2 (i.e., with the pump turned off), and the depletion event experienced by the fluid delivery device may correspond to an out-of-ink event in which the printing fluid supply that supplies printing fluid to the pump is depleted.

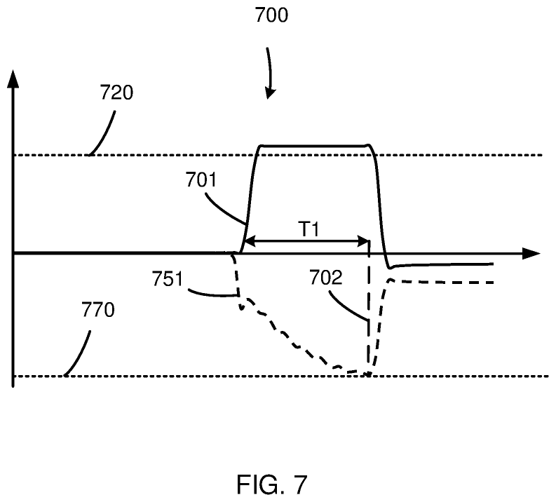

Referring now to FIG. 7, a line chart 700 representing a first pressure profile 701 and a second pressure profile 751 is shown. The first pressure profile 701 corresponds to the pressure values measured using a first pressure sensor (e.g., first pressure sensor 309 in the fluid delivery device 300A) positioned downstream a first pump (e.g., the first pump 105, 205, and 305) of the fluid delivery device and the second pressure profile 751 corresponds to the pressure values measured using a second pressure sensor (e.g., auxiliary pressure sensor 359 in the fluid delivery device 300B) positioned upstream a second pump (e.g., the auxiliary pump 353) of the fluid delivery device.

As explained above, a fluid delivery device may use a first pump to move printing fluid towards a printhead and an auxiliary pump to create a back pressure towards the printhead. In an example, the fluid delivery device may have a first printhead port connected to the printhead and a second printhead port connected to the printhead. The fluid delivery device may comprise a pump to move printing fluid towards the printhead via the first printhead port and an auxiliary pump to move printing fluid from the second printhead port to a second supply port of the fluid delivery device. By creating a back pressure using the auxiliary pump as the pump moves printing fluid to the printhead, a recirculation-through-printhead may be performed along a fluid path including the printhead and the auxiliary pump.

In line chart 700, a first reference line 720 and a second reference line 770 represent pressure values associated with a printhead blockage event when using an auxiliary pump to move printing fluid through the printhead of the fluid delivery device. Over the period T1, the pump and the auxiliary pump operate such that the printing fluid moves through the printhead, thereby implementing a recirculation-through-printhead mode of the fluid delivery device. As the printing fluid moves towards the printhead, the first pressure profile 701 exceeds the first reference line 720. Then, at time 702, the second pressure profile 751 intersects the second reference line 770, thereby indicating the presence of an element that blocks a fluid path through the printhead. In some examples, a controller of the fluid delivery device may determine a printhead blockage upon the pressure measured by the first sensor exceeds a first blockage pressure value associated with a printhead blockage and a second pressure value decreases below a second blockage pressure value.

According to some examples, a method for performing operations involving printing fluid in a printing system may involve operating a fluid delivery device such as the fluid delivery devices 100, 200A, 200B, 300A, and 300B previously explained in reference to FIGS. 1 to 3B.

In some examples, a printing method may comprise operating a fluid delivery device in pressure-controlled mode or a recirculation mode, wherein operating the fluid delivery device in the pressure-controlled mode comprises setting a recirculation valve of the fluid delivery device in a closed position and moving printing fluid along a feeding path towards a second supply port and along a return fluid path including a pressure relief valve. In an example, operating the fluid delivery device in the pressure-controlled mode comprises operating a printing fluid pump of the fluid device at a pressure greater than a set pressure of the pressure relief valve. As a result, the pressure relief valve opens and the printing fluid moves along the return fluid path. In some other examples, operating the fluid delivery device in the recirculation mode comprises operating the pump at a pressure lower than a set pressure of the relief valve.

What has been described and illustrated herein are examples of the disclosure along with some variations. The terms, descriptions, and figures used herein are set forth by way of illustration only and are not meant as limitations.

Many variations are possible within the scope of the disclosure, which is intended to be defined by the following claims (and their equivalents) in which all terms are meant in their broadest reasonable sense unless otherwise indicated.

What is claimed is:

1. A fluid delivery device comprising:
a printing fluid pump;
a return fluid path including a pressure relief valve to receive printing fluid from an outlet of the pump; and
a recirculation valve movable between:
an open position in which a recirculation path from the outlet of the pump towards a supply port connectable to a printing fluid supply is established, and a closed position in which a feeding path from the outlet of the pump towards a printhead port is established,
wherein the fluid delivery device comprises a pressure-controlled mode in which the recirculation valve is in the closed position and the pump is to operate at a pressure sufficient to open the pressure relief valve.

2. The fluid delivery device of claim 1, wherein the fluid delivery device further comprises a recirculation mode in which the recirculation valve is in the open position and the pump is to operate at a pressure insufficient to open the pressure relief valve.

3. The fluid delivery device of claim 1, further comprising:
a recirculation line to fluidly connect the outlet of the pump with a second supply port and including the recirculation valve; and
an auxiliary printhead port fluidly connected to a portion of the recirculation line downstream the recirculation valve,
wherein upon a dummy printhead is connected to the printhead port and the auxiliary port, the fluid delivery device further comprises a through-dummy recirculation mode in which the recirculation valve is in the closed position, the pump is to operate at a pressure insufficient to close the pressure relief valve, and the recirculation path includes a fluid path along the dummy printhead towards the second supply port.

4. The fluid delivery device of claim 1, further comprising:
a first supply port to be connected to a first printing fluid supply; and
a second supply port to be connected to a second, different, printing fluid supply,
wherein an inlet of the pump is in fluidic communication with one of the first supply port and the second supply port, and wherein in the open position of the recirculation valve, the recirculation path is established from the outlet of the pump to one of the first supply port and the second supply port.

5. The fluid delivery device of claim 4, further comprising a valve assembly switchable between:
a forward state in which the inlet of the pump is fluidly connected to the first supply port and the recirculation path is established from the outlet of the pump towards the second supply port, and
a reverse state in which the inlet of the pump is fluidly connected to the second supply port and the recirculation path is defined from the outlet of the pump towards the first supply port,
wherein the fluid delivery device further comprises a recirculation mode in which the recirculation valve is in the open position and the pump is to operate at a pressure insufficient to open the pressure relief valve.

6. The fluid delivery device of claim 1, wherein the pressure relief valve has a set pressure within a pressure range from 65 kPa to 85 kPa.

7. A printing system comprising:
a printing fluid supply;
a fluid delivery device comprising a pressure-controlled mode in which a pump in fluidic communication with the printing fluid supply is to operate at a pressure sufficient to open a pressure relief valve in fluidic communication with an outlet of the pump, the device including a recirculation valve movable between an open position in which a recirculation path from the outlet of the pump towards a second supply port is established and a closed position in which a feeding path from the outlet of the pump to a printhead port is established; and
a controller to operate the recirculation valve based on an operating mode of the fluid delivery device,
wherein in the pressure-controlled mode, the recirculation valve is in the closed position.

8. The printing system of claim 7, wherein the fluid delivery device further comprises a recirculation mode in which the pump is to operate at a pressure insufficient to open the pressure relief valve.

9. The printing system of claim 7, further comprising:
a recirculation line to fluidly connect the outlet of the pump with the second supply port, the recirculation line including the recirculation valve; and
a pressure sensor to measure a pressure in a fluid path defined downstream the return fluid path and upstream the recirculation line,
wherein the controller is to determine a malfunction event in the fluid delivery device based on the measured pressure and the operating mode of the fluid delivery device.

10. The printing system of claim 9, wherein the controller to determine the malfunction event comprises the controller to determine:
a printhead blockage event upon the measured pressure is greater than a blockage pressure value, and
a depletion event upon the measured pressure is lower than a depletion threshold value.

11. The printing system of claim 7, further comprising:
a recirculation line to fluidly connect the outlet of the pump with a second supply port, the recirculation line including the recirculation valve and an auxiliary pump having an outlet in fluidic communication with the second supply port, and
an auxiliary printhead port fluidly connected to an inlet of the auxiliary pump,
wherein upon a printhead is connected to the printhead port and the auxiliary printhead port, the fluid delivery device further comprises a through-printhead recirculation mode in which the recirculation valve is in the closed position, the pump is to operate at a pressure sufficient to open the pressure relief valve, and the auxiliary pump is operate at a threshold back pressure.

12. The printing system of claim 11, further comprising:
a pressure sensor to measure a first pressure downstream the return fluid path; and
an auxiliary sensor to measure a second pressure upstream the inlet of the auxiliary pump,
wherein the controller is to determine a malfunction event in the fluid delivery device based on the measured pressures and the operating mode of the fluid delivery device.

13. A printing method comprising operating a fluid delivery device in a pressure-controlled mode or a recirculation mode, the fluid delivery device comprising:
a printing fluid pump,
a return fluid path including a pressure relief valve to receive printing fluid from an outlet of the pump, the return fluid path fluidly connected to a region upstream the pump, and
a recirculation valve movable between:
an open position in which a recirculation path from an outlet of the pump towards a supply port is established, and
a closed position in which a feeding path from the outlet of the pump towards a printhead port is established,
wherein operating the fluid delivery in the pressure-controlled mode comprises setting the recirculation valve in the closed position and moving printing fluid along the feeding path and the return fluid path.

14. The method of claim 13, wherein operating the fluid delivery device in the pressure-controlled mode comprises operating the pump at a pressure greater than a set pressure of the pressure relief valve.

15. The method of claim 13, wherein operating the fluid delivery device in the recirculation mode comprises operating the pump at a pressure lower than a set pressure of the pressure relief valve.
